(19) United States
(12) Patent Application Publication
(10) Pub. No.: US 2010/0305985 A1
(43) Pub. Date: Dec. 2, 2010

(54) Contract management system

(76) Inventors: James P. Wartho, London (GB); David Steinberg, London (GB); Noel R. Goddard, Chichester (GB)

Correspondence Address: OLIFF & BERRIDGE, PLC, P.O. BOX 320850, ALEXANDRIA, VA, 22320-4850, US

(21) Appl. No.: 12/453,993

(22) Filed: May 28, 2009

(51) Int. Cl. G06Q 40/00; G06Q 30/00; G06Q 10/00; G06F 15/16; G06Q 20/00; G06F 17/28

(52) U.S. Cl. 705/7; 705/31; 705/34; 705/38; 705/40; 709/204; 704/2

(57) ABSTRACT

A contract management system is disclosed for managing a contract between a supplier and a purchaser, the system comprising a stage payment management unit for receiving contract information from a supplier terminal and creating a payment schedule and an interface unit for providing a communication interface between the contract management system, the supplier terminal and a purchaser terminal. The system also includes a foreign exchange pricing engine for receiving a request from the purchaser via the communication interface for an exchange rate for making one of the payments in a second currency, retrieving a current exchange rate between the second and first currencies from a exchange rate database and notifying the purchaser of the exchange rate via the communication interface. A foreign exchange hedging engine is also provided, for purchasing an amount of the first currency corresponding to the payment based on the exchange rate.

### FIELD OF THE INVENTION

The present invention relates to a contract management system and a contract management method for setting up and managing a payment contract between two or more parties.

### BACKGROUND

Typically, when a supplier of goods or services wishes to enter into a contract with a purchaser, a fragmented system of paper invoices, telephone calls, faxes and find transfers between local banks is used to set up the contract and manage payments due under the contract. Since efficient management of the contract is dependent on the system put in place by the purchaser for making payments, the supplier cannot rely on payments under the contract being made on time. Furthermore, a supplier generally has concurrent contracts with several purchasers. Payments received by the supplier often lack an adequate identifying reference, in which case it may be difficult to match the payments with payments expected from purchasers.

The administration costs of the contract can be high because the supplier must chase late payments and often communicate with purchasers in several languages. In addition, it is difficult for the supplier to make cash flow predictions because generally the supplier will only discover that a payment will not be made on time when it fails to arrive in their bank account.

This system is particularly problematic when the supplier and purchaser are in different countries having different currencies. In this situation, a currency broker is used to convert payments made by the purchaser under the contract in one currency into the currency accepted by the supplier. The cost of administration of the contract is increased by the fees charged by the broker for currency exchange.

In view of the above, it is an object of the present invention to provide a contract management system that can reduce the costs and uncertainties associated with administrating a contract between parties in different countries using different currencies.

### SUMMARY OF THE INVENTION

According to a first aspect of the present invention, there is provided a contract management system for managing a contract between a supplier and a purchaser, comprising: a stage payment management unit for receiving contract information from a supplier terminal and creating a payment schedule corresponding to the contract information, the payment schedule including one or more payments in a first currency, times at which the payments must be made under the contract and current statuses of the payments; a storage unit for storing the payment schedule; an interface unit for providing a communication interface between the contract management system, the supplier terminal and a purchaser terminal, so as to allow the payment schedule to be accessed from the supplier terminal and the purchaser terminal; a foreign exchange pricing engine for receiving a request from the purchaser via the communication interface for a exchange rate for making one of the payments in a second currency, retrieving a current exchange rate between the second and first currencies from a exchange rate database and notifying the purchaser of the exchange rate via the communication interface; and a foreign exchange hedging engine for receiving a request from the purchaser via the communication interface to fix the exchange rate for the payment and purchasing an amount of the first currency corresponding to the payment based on the exchange rate.

The contract management system of the invention provides a payment schedule accessible by both the supplier and the purchaser, which makes it easy for the supplier to keep track of which payments due under the contract have been made and which are outstanding. The system also provides an integrated currency exchange function, which allows payments to be made by the purchaser in one currency and received by the supplier in another currency without using a currency broker.

Preferably, the stage payment management unit updates the status of the payment in the payment schedule to indicate that the exchange rate has been fixed after the request to fix the exchange rate has been received.

Conveniently, the stage payment management unit updates the status of the payment in the payment schedule to indicate that the payment has been activated in response to receiving a request to make the payment from the purchaser via the communication interface.

Preferably, the contract management system further comprises: an international payments engine for transferring the payment amount in the first currency to the supplier in response to receiving confirmation that the payment amount in the second currency has been received from the purchaser at a bank account linked to the contract management system.

Suitably, the stage payment management unit updates the status of the payment in the payment schedule to indicate that the payment has been made after the payment amount in the second currency has been received.

According to a second aspect of the present invention, there is provided a contract management method for managing a contract between a supplier and a purchaser, comprising performing the following steps in a contract management system: receiving contract information from a supplier terminal and creating a payment schedule corresponding to the contract information, the payment schedule including one or more payments in a first currency, times at which the payments must be made under the contract and current statuses of the payments; storing the payment schedule; providing a communication interface between the contract management system, the supplier terminal and a purchaser terminal, so as to allow the payment schedule to be accessed from the supplier terminal and the purchaser terminal; receiving a request from the purchaser via the communication interface for a exchange rate for making one of the payments in a second currency; retrieving a current exchange rate between the second and first currencies from a exchange rate database; notifying the purchaser of the exchange rate via the communication interface; receiving a request from the purchaser via the communication interface to fix the exchange rate for the payment; and purchasing an amount of the first currency corresponding to the payment based on the exchange rate.

### BRIEF DESCRIPTION OF THE DRAWINGS

Embodiments of the present invention will now be described by way of further example only and with reference to the accompanying drawings, in which:

FIG. 1 is a schematic diagram illustrating the communication links between a system according to an embodiment of the invention and the parties involved in the contract;

FIG. 2 illustrates the architecture of a system according to an embodiment of the invention;

FIG. 3 is a screenshot showing a payment schedule for a pending contract managed by a system according to an embodiment of the invention; and

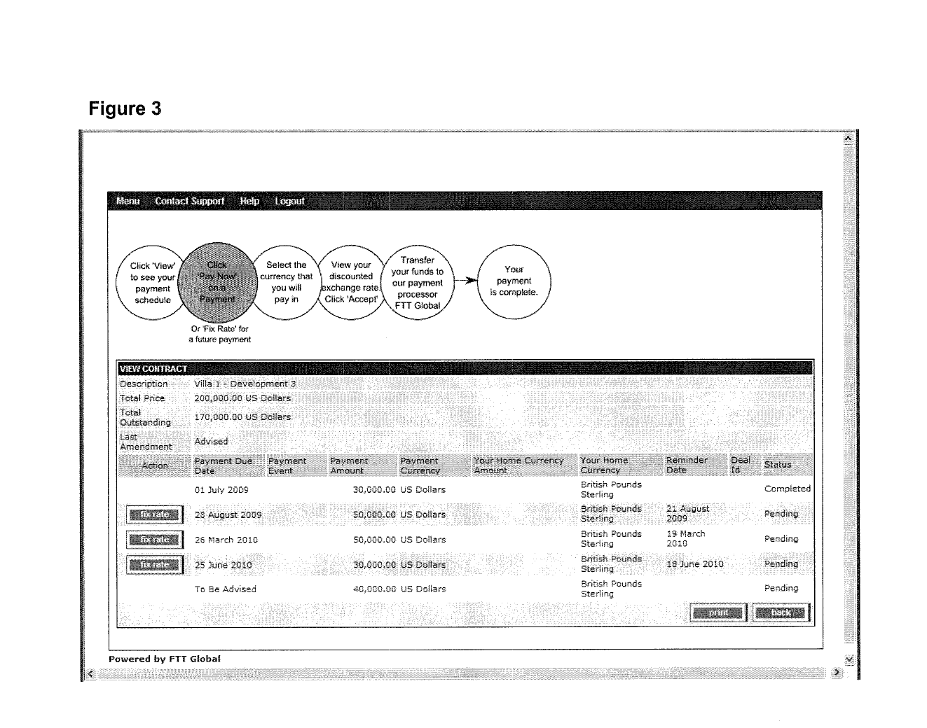

FIG. 4 is a screenshot showing the operation of setting up a contract using a system according to an embodiment of the invention.

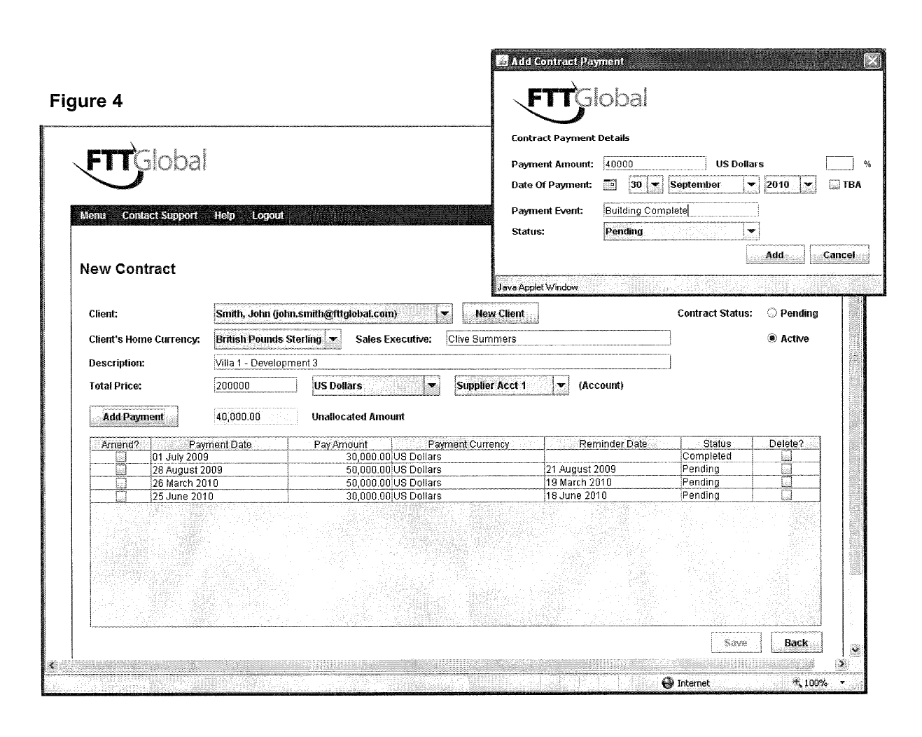

### DETAILED DESCRIPTION

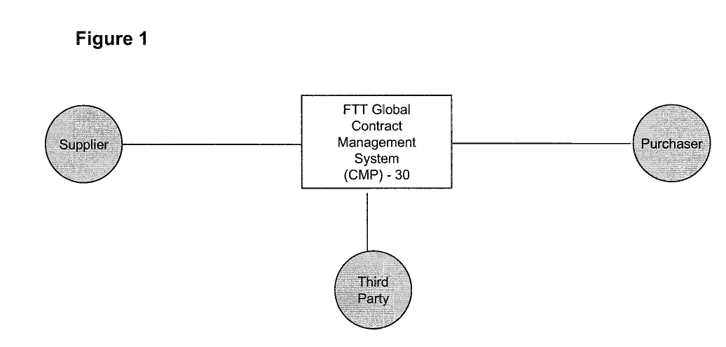

As illustrated in FIG. 1, a contract management system 30 of the present invention acts as an intermediary between a supplier, a purchaser and any third parties involved in the execution of a contract. The supplier in FIG. 1 can be any seller of goods and/or services, including but not limited to a property developer. The purchaser is a party who has entered into a contract with the supplier to purchase goods and/or services. The third party can be any third party with a legitimate interest in the transaction covered by the contract. For example, the third party could be a shipping agent contracted to transport goods between the supplier and the purchaser.

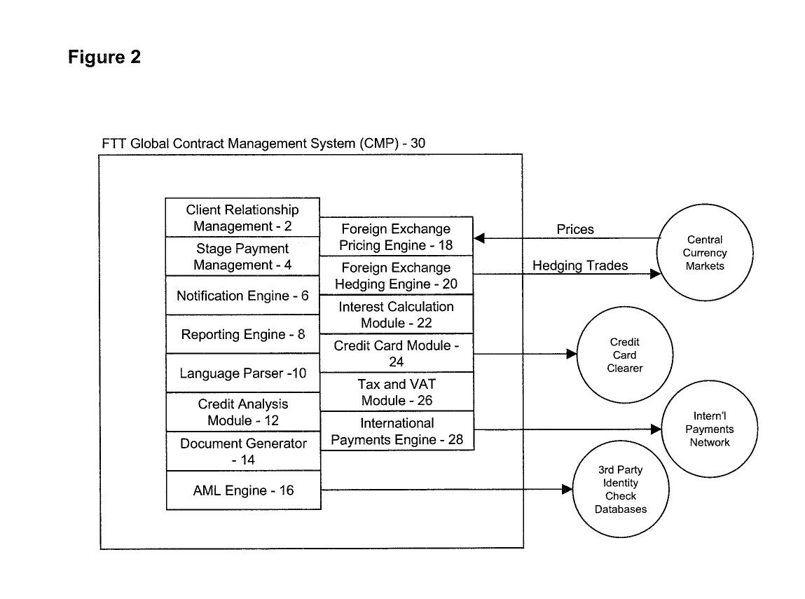

The structure of the contract management system 30 of an embodiment is shown in FIG. 2. The modules shown on the left hand side in the drawing handle the interface between the system and the supplier and purchaser, whereas the modules shown on the right hand side handle currency exchange and payments.

The client relationship management module 2 stores a history of interactions between suppliers, purchasers and third parties. The client relationship management module 2 also provides access to the stored history for the supplier so that the supplier can keep track of past transactions with a given purchaser or third party.

The stage payment management module 4 handles setting up and maintaining stage payment schedules associated with contracts managed by the system. A stage payment schedule is a list of payments due to be made by the purchaser to the supplier under a contract, the due date by which each payment must be made and the current status of the payment. The stage payment management module 4 provides an interface that allows the supplier to create a desired stage payment schedule for a contract and automatically updates the status of each payment in the schedule as execution of the contract progresses. The module also allows the supplier to view the schedule on demand. Hence, the supplier can straightforwardly view the current status of all payments under a given contract and determine the payments under the contract expected in the near future. This avoids the administrative costs of collating information on payments under each contract for the supplier.

The notification engine 6 automatically generates and sends communications to the supplier, the purchaser and any third parties. For example, the notification engine 6 can automatically send a reminder to the purchaser when the system determines that a payment is due in the near future or has become overdue. The supplier can create a set of rules determining under what circumstances the notification engine 6 sends communications. This reduces the cost associated with sending routine communications to the other parties involved in the contract for the supplier.

The reporting engine 8 generates reports detailing payment statuses and other information relating to particular purchasers, third parties or groups of contracts. Using the reporting engine 8, the supplier can run reports across all contracts and thereby filter the information on outstanding and completed contracts stored in the system for analysis. For example, the supplier can run an overdue payment report to collect details on all payments that are currently overdue, or a cash flow report showing all transactions due in a specified period. The cash flow report is particularly useful as it allows the supplier to predict income in the specified period.

The language parser 10 converts information provided to the supplier, purchasers and third parties by the system into an appropriate language. For example, if the supplier is in the UK and the purchaser is in France, the language parser 10 will ensure that the system presents information to the supplier in English and to the purchaser in French. In this case, the supplier sets up the contract and payment schedule in English using an English interface, but the system presents the payment schedule to the purchaser in French using the language parser 10. Notifications sent to the purchaser such as payment reminders would also be in the appropriate language.

The credit analysis module 12 performs credit analyses on purchasers based on the information stored in the system regarding past payments on pending and completed contracts as well as any steps taken by the purchaser to make currently outstanding payments. The credit analyses performed by the credit analysis module 12 determine the likelihood of the purchaser to pay and any intent to pay that has been demonstrated by the purchaser. The purchaser uses the contract management system 30 itself to make a payment in the embodiment. Hence, the system knows when a purchaser requests a payment to be made, which may be up to a week before funds actually arrive in the supplier's bank account. Accordingly, the delay between a payment being submitted and the supplier becoming aware of it is eliminated. This information is valuable to the supplier because it provides early warning of payments that are likely to be missed. Previously, a supplier would generally not be aware that a payment is likely to be missed until it fails to arrive in the supplier's bank account. Thus the contract management system 30 of this embodiment allows a supplier to forecast their income from payments on a particular contract more accurately.

The document generator 14 generates standard documents relevant to purchasing processes under contracts handled by the system. For example, the document generator 14 may create and send a standard default letter to a purchaser when the system detects that purchaser has defaulted on a payment. The document generator 14 is capable of creating the standard documents in several different languages so that they can be sent to the recipient party in that party's native language. The system allows each supplier to customise the standard documents sent via the online interface. The document generator 14 can either send the standard documents via email or make them available over an internet-based interface.

The AML (Anti Money Laundering) engine 16 is connected to one or more external identity checking databases. The AML engine 16 receives identity information on the purchaser, which is either entered by the supplier or entered by the purchaser at the request of the contract management system 30. This identity information is checked against information in the identity checking database to ensure that the information given is accurate. In a conventional system of contract management, the supplier would need to perform such checks manually, which leads to increased administration costs.

The foreign exchange pricing engine 18 provides an exchange rate between a purchaser's home currency and the supplier's home currency. Since the foreign exchange pricing engine 18 is in constant contact with central currency markets, the exchange rate provided is updated by the second. This allows a much more accurate exchange rate to be provided than in a conventional contract management process.

The foreign exchange hedging engine 20 automatically buys the necessary amount of the supplier's home currency for the purchaser as soon as a payment is made or a purchaser requests that the exchange rate for a payment be fixed. This ensures that the currency is bought at the rate offered to the purchaser and avoids fluctuations in exchange rates adversely affecting the supplier.

The interest calculation module 22 calculates and applies the interest due on late payments. The tax and VAT module 26 similarly calculates the taxation and VAT due on payments.

The international payments engine 28 tracks inbound payments to the contract management system 30. Information on the status of inbound payments can be provided to other parts of the system by the international payments engine 28 as required. The international payments engine 28 is also responsible for sending domestic and international bank wires to suppliers when payments are received.

By providing the above components in a single integrated system, the contract management system 30 encapsulates the entire payment process. The functions of international remittance, payment schedule communication, currency exchange and internal financing reporting are all combined in, and automated by, the contract management system 30.

The process of setting up and managing a contract using the system of one embodiment of the invention is described below.

The system provides an online interface that allows the supplier to access all information held on the system relating to the supplier's contracts and payment statuses. The supplier sets up new contracts on the system using this interface. In this embodiment, the supplier enters the purchaser's details including name, address, date of birth and passport number. The system passes these details to the AML engine 16, which will perform standard KYC (Know Your Client) checks on the information. The supplier enters the purchaser's home currency, which the system will use to generate currency exchanges when payments are made by the purchaser.

The supplier also enters a description of the contract, which will be used as a reference in all electronic communications with the purchaser and will be tagged to all payments received by the supplier from the purchaser under the contract. This ensures that all communications relating to the contract are easily identifiable. Finally, the supplier enters a stage payment schedule for the contract, consisting of one or more stage payments together with associated due dates.

Once all the information has been entered, the contract information is saved in a database stored on the system. The system then automatically notifies the purchaser that the contract has been created, for example by email.

The supplier can amend a pending contract at any time via the interface. For example, the supplier could log in to the system and postpone the due date for a payment to reflect a delay in performing a particular stage in the contract. Whenever an amendment is made to a contract the system notifies the purchaser immediately. The notification asks the purchaser to log in to the system to review the revised contract.

The purchaser can log in to the system at any time to view their payment schedule. The system provides an interface using which the purchaser can choose to make a payment or fix the exchange rate for a future payment.

When the purchaser opts to make a payment due under the contract, the system allows the purchaser to select any currency for payment. The foreign exchange pricing engine 18 then obtains an up to date exchange rate between the currency required by the supplier and the selected currency, and calculates the equivalent amount of the payment in the selected currency. The system has access to central currency markets and therefore can offer wholesale exchange rates, which will save the purchaser a significant amount of money when compared to transferring funds for payments through a bank or currency broker.

Once the purchaser has performed the payment on the system and received the exchange rate, the purchaser must send payment to the system operator. The finds for this payment are transferred between the purchaser's bank account and the system operator's bank account in the usual way. The system operator maintains a local bank account in each country in which a supplier or purchaser using the system is located. Hence, the payment from the purchaser to the system operator only requires a local bank transfer and can usually be performed in a single day. Following a payment by the purchaser using the system, the system sends the purchaser a full receipt for the payment including taxes, for example by email.

In addition to making a payment, the interface allows the purchaser to fix an exchange rate for a future payment several years in advance. This exchange rate is then guaranteed by the system operator, regardless of fluctuations in exchange rates between fixing the rate and making the payment. The system may require the purchaser to transfer a deposit to the system operator in order to fix the exchange rate. The exchange rate fixing facility allows the purchaser to avoid the risk of currency fluctuations adversely affecting the cost of payments in future. In this embodiment, when the purchaser opts to fix an exchange rate the system buys the appropriate amount of the currency required by the supplier for the payment. Thus, the system protects the system operator from the effect of future currency fluctuations.

When payment from the purchaser is received by the system operator, the system notifies the purchaser immediately. When a payment is imminent and the purchaser has not performed the payment on the system yet, the system sends an automatic payment reminder to the purchaser.

The system notifies the supplier whenever a payment is made or changes status. The supplier can log in to the system and view the status of payments due under a given contract at any time. In this embodiment, payments can have the following statuses:

(i) Pending—this means that the payment is due in the future and no action has been taken by the purchaser.

(ii) Due—this means that the payment is due in the near future.

(iii) Awaiting payment—this means that the purchaser has activated the payment on the system and fixed an exchange rate for the payment.

(iv) Payment received—this means that the purchaser's payment has been received by the system operator.

(v) Deposit received—this indicates that the purchaser has transferred the deposit required to fix an exchange rate to the system operator.

(vi) Complete—this indicates that the purchaser's funds for a payment have been sent to the supplier by the system operator.

The system can automatically notify the supplier of changes between any of these statuses. It is preferred that the system notifies the supplier at least when a purchaser makes a payment on the system and when the system operator receives the purchaser's funds.

The interface of the system in this embodiment allows the supplier to see when the following events occur by logging in to the system:

(i) The purchaser being reminded of a payment

(ii) The purchaser reading a payment reminder

(iii) The purchaser logging into the system to view the payment schedule

(iv) The purchaser viewing an exchange rate for a payment but declining the payment

(v) A payment becoming overdue

The supplier may also be automatically notified by the system whenever one of these events occurs. Due to the system of this embodiment supplying the information discussed above to the supplier, the supplier is able to determine what the purchaser's intentions are regarding upcoming payments with a reasonable degree of confidence. A supplier using the system of the embodiment is able to evaluate how likely a purchaser is to default on a payment before the payment actually becomes overdue. This assists in the supplier's business planning. In contrast, in a conventional contract management process the only information available to the supplier regarding how likely a purchaser is to default is whether the funds arrive on the due date.

Since the system includes the tax and VAT module 26, the system is able to calculate taxes due on all payments made under the contract automatically. When tax is paid on a transaction, the amount of tax is laid out in the relevant receipts and notifications generated by the system.

When a purchaser makes a late payment, the interest calculation module 22 generates the interest charges due. The system may either add the interest to the next stage payment or create a new payment requiring the purchaser to pay the interest separately.

While the above description only refers to bank transfers, the system is also capable of accepting credit card payments from purchasers, using the credit card module 24. The system operator can receive payments made using a credit card via the system and process the payment in the same way as when funds are received by bank transfer.

The infrastructure provided by the contract management system 30 connects the financial flows between the suppliers, purchasers and third parties across international borders and currencies. The system links the actions of the parties involved to the associated movements of funds, thereby providing greater transparency in the contract management process. For the supplier, the advantages of the system include instant notification of payment status and advance warning of funds on the way to the supplier. In addition, using the system of the invention all payments are clearly referenced to the relevant contract when they are received by the supplier. The administration costs of managing payment schedules, inbound payments and debt collection are greatly reduced for the supplier. Since the suppliers and third parties are notified instantly when payments are made by purchasers, good and services can be released earlier than in a conventional contract management process.

For the purchaser, better currency exchange prices are provided since no brokers are involved. The costs of wiring funds internationally are also reduced or avoided. For all parties, the process of fulfilling a contract is greatly simplified due to the fact that they can interact with the system in their native language.

The following is a specific example of a contract management process performed using an embodiment of the contract management system 30 of the invention.

In this example, a property developer in Dubai sells individual properties to clients located all over the world. The property developer is the supplier and has UAE Dirhams as a local currency.

The purchasers are 1200 private individuals located in countries including the US, UK, France and Japan. A real estate agent charged with releasing the keys to each property once the final stage payment is received acts as a third party. In a first scenario, a US based client purchases a property from the supplier.

Firstly, the supplier enters details of the purchaser into the contract management system 30. The system then validates the passport details, name and address of the purchaser using an external database and reports any discrepancies to the supplier. The supplier also creates and stores details of the stage payment schedule for the purchaser on the system.

The contract management system 30 sends an email to the purchaser notifying the purchaser that a contract has been set up on the system. The purchaser can then log in to the system to view their stage payment schedule.

One week before the first payment is due, the contract management system 30 sends a reminder email to the purchaser. The purchaser then logs in to the system and selects a “pay now” option to make the payment. The currency exchange rate is then fixed by the system for that payment. The exchange rate offered is a wholesale rate, which saves the purchaser money compared to currency exchange using a bank or broker. The system automatically buys an amount of UAE Dirhams equal to the payment amount for the system operator, on behalf of the purchaser.

The purchaser wires the payment in US dollars to the system operator, which holds bank accounts locally in the US. The system operator will receive the finds from the purchaser on the same day, whereas the international money transfers used in conventional purchasing processes can take up to a week. The system then notifies the supplier that the system operator has received payment and the purchaser's funds are cleared. The system operator sends the payment in UAE Dirhams to the supplier. The payment received by the supplier is fully referenced to the particular property being purchased.

The contract management system 30 automatically notifies the third party real estate agent in Dubai when the final stage payment is received by the system operator. The real estate agent can then release the keys to the property immediately, rather than waiting for an international wire transfer to arrive and then for the supplier to allocate the payment to the correct contract.

The property is released 7 to 10 days earlier when using the contract management system 30 compared to a conventional purchasing process.

In a second scenario, a European client defaults on a payment. As in the first scenario, the contract management system 30 sends an email reminder to the purchaser one week before the payment is due. The system informs the supplier that the email has been sent and also informs the supplier when the purchaser has read the email. The purchaser logs in to the system to view their stage payment schedule. The system informs the supplier that this has occurred.

After logging in to the system, the purchaser requests an exchange rate for making the payment in their home currency but declines to make the payment. This action is also reported to the supplier by the system. At this stage, the supplier is already aware that there is a high chance of default on the payment due to the information provided by the system.

The purchaser then fails to make the payment by the due date. At this stage, the supplier can be certain that the purchaser has defaulted on the payment because the information from the system shows that the purchaser was aware that the payment was due but has not transferred the necessary funds. The supplier can then take appropriate action without having to wait to be sure that the purchaser has not wired funds that are late arriving.

The aforegoing description has been given by way of example only and it will be appreciated by a person skilled in the art that modifications can be made without departing from the scope of the present invention.

1. A contract management system for managing a contract between a supplier and a purchaser, comprising:
a stage payment management unit for receiving contract information from a supplier terminal and creating a payment schedule corresponding to the contract information, the payment schedule including one or more payments in a first currency, times at which the payments must be made under the contract and current statuses of the payments;
a storage unit for storing the payment schedule;
an interface unit for providing a communication interface between the contract management system, the supplier terminal and a purchaser terminal, so as to allow the payment schedule to be accessed from the supplier terminal and the purchaser terminal;
a foreign exchange pricing engine for receiving a request from the purchaser via the communication interface for a exchange rate for making one of the payments in a second currency, retrieving a current exchange rate between the second and first currencies from a exchange rate database and notifying the purchaser of the exchange rate via the communication interface; and
a foreign exchange hedging engine for receiving a request from the purchaser via the communication interface to fix the exchange rate for the payment and purchasing an amount of the first currency corresponding to the payment based on the exchange rate.

2. A contract management system according to claim 1, wherein the stage payment management unit updates the status of the payment in the payment schedule to indicate that the exchange rate has been fixed after the request to fix the exchange rate has been received.

3. A contract management system according to claim 1, wherein the stage payment management unit updates the status of the payment in the payment schedule to indicate that the payment has been activated in response to receiving a request to make the payment from the purchaser via the communication interface.

4. A contract management system according to claim 1, further comprising:
an international payments engine for transferring the payment amount in the first currency to the supplier in response to receiving confirmation that the payment amount in the second currency has been received from the purchaser at a bank account linked to the contract management system.

5. A contract management system according to claim 4, wherein the stage payment management unit updates the status of the payment in the payment schedule to indicate that the payment has been made after the payment amount in the second currency has been received.

6. A contract management system according to claim 1, further comprising:
a reporting engine for producing reports containing selected information on selected contracts managed by the contract management system.

7. A contract management system according to claim 1, further comprising:
a notification engine for generating and sending a reminder communication to the purchaser in response to the stage payment management unit detecting that a predetermined time remains before a payment in the payment schedule is due.

8. A contract management system according to claim 7, wherein the notification engine notifies the supplier when a status of a payment in the payment schedule changes.

9. A contract management system according to claim 7, wherein the notification engine notifies the supplier when the purchaser requests a payment to be made and when a system operator receives funds from the purchaser.

10. A contract management system according to claim 7, wherein the notification engine notifies the supplier when the purchaser accesses the payment schedule.

11. A contract management system according to claim 1, further comprising:
a language conversion unit for determining the local language of the purchaser based on the contract information and translating the communication interface provided to the purchaser terminal by the interface unit into the local language of the purchaser.

12. A contract management system according to claim 1, further comprising:
a tax calculation unit for automatically calculating the tax payable on each of the payments in the payment schedule.

13. A contract management system according to claim 1, further comprising:
an interest calculation unit for automatically calculating the interest payable on any overdue payments in the payment schedule.

14. A contract management system according to claim 1, further comprising:
an anti money laundering engine for receiving identity information on the purchaser and checking the identity information against an external identity database.

15. A contract management system according to claim 14, wherein the anti money laundering engine determines whether the identity information is consistent with the external identity database and supplies the result of the determination to the notification engine, and wherein the notification engine notifies the supplier of the result of the determination.

16. A contract management system according to claim 1, further comprising:
a credit analysis unit for compiling information on payments for contracts between the supplier and a selected purchaser, from payment schedules stored in the storage unit, and calculating the likelihood of the selected purchaser defaulting on future payments based on the compiled information.

17. A contract management system according to claim 16, wherein the compiled information includes the number of payments for contracts between the supplier and the selected purchaser that have become overdue.

18. A contract management system according to claim 16, wherein the compiled information includes the number of times that the selected purchaser has requested a exchange rate for a payment but has not requested that the payment be made.

19. A contract management method for managing a contract between a supplier and a purchaser, comprising performing the following steps in a contract management system:
receiving contract information from a supplier terminal and creating a payment schedule corresponding to the contract information, the payment schedule including one or more payments in a first currency, times at which the payments must be made under the contract and current statuses of the payments;
storing the payment schedule;
providing a communication interface between the contract management system, the supplier terminal and a purchaser terminal, so as to allow the payment schedule to be accessed from the supplier terminal and the purchaser terminal;
receiving a request from the purchaser via the communication interface for a exchange rate for making one of the payments in a second currency;
retrieving a current exchange rate between the second and first currencies from a exchange rate database;
notifying the purchaser of the exchange rate via the communication interface;
receiving a request from the purchaser via the communication interface to fix the exchange rate for the payment; and
purchasing an amount of the first currency corresponding to the payment based on the exchange rate.

20. A contract management method according to claim 19, further comprising:
updating the status of the payment in the payment schedule to indicate that the exchange rate has been fixed after the request to fix the exchange rate has been received.

21. A contract management method according to claim 19, further comprising:
receiving a request to make the payment from the purchaser via the communication interface; and
updating the status of the payment in the payment schedule to indicate that the payment has been activated.

22. A contract management method according to claim 19, further comprising:
receiving confirmation that the payment amount in the second currency has been received from the purchaser at a bank account linked to the contract management system; and
transferring the payment amount in the first currency to the supplier.

23. A contract management method according to claim 22, further comprising:
updating the status of the payment in the payment schedule to indicate that the payment has been made after the payment amount in the second currency has been received.

24. A contract management method according to claim 19, further comprising:
receiving identity information on the purchaser; and
checking the identity information against an external identity database.
